(19) United States
(12) Patent Application Publication
(10) Pub. No.: US 2010/0246918 A1
(43) Pub. Date: Sep. 30, 2010

(54) ITERATIVE EXTRA-FOCAL RADIATION CORRECTION IN THE RECONSTRUCTION OF CT IMAGES

(76) Inventors: Steffen Kappler, Effeltrich (DE); Ernst-Peter Rührnschopf, Erlangen (DE); Bernhard Scholz, Heroldsbach (DE); Karl Stierstorfer, Erlangen (DE)

Correspondence Address: HARNESS, DICKEY & PIERCE, P.L.C., P.O.BOX 8910, RESTON, VA, 20195, US

(21) Appl. No.: 12/730,664

(22) Filed: Mar. 24, 2010

(30) Foreign Application Priority Data
Mar. 26, 2009 (DE) 10 2009 015 032.3

(51) Int. Cl. G06K 9/00; H05G 1/60

(52) U.S. Cl. 382/131; 378/4

(57) ABSTRACT

A method is disclosed for reconstruction of image data of an object under examination from measurement data, with the measurement data having been recorded during a rotating movement of a radiation source of a computed tomography system around the object under examination. The radiation source emits focal and extra-focal radiation. In at least one embodiment of the method, the image data is determined from the measurement data by use of an iterative algorithm. A variable is used in the iterative algorithm which contains a distribution of the extra-focal radiation.

### PRIORITY STATEMENT

The present application hereby claims priority under 35 U.S.C. §119 on German patent application number DE 10 2009 015 032.3 filed Mar. 26, 2009, the entire contents of which are hereby incorporated herein by reference.

### FIELD

At least one embodiment of the invention generally relates to a method for reconstructing image data of an object under examination from measurement data, with the measurement data being recorded during a rotating movement of a radiation source of a computed tomography system around the object under examination.

### BACKGROUND

Methods for scanning an object under examination with a CT system are generally known. Typical methods employed in such cases are orbital scans, sequential orbital scans with advance or spiral scans. In these scans absorption data of the object under examination is recorded from different recording angles with the aid of at least one x-ray source and at least one detector lying opposite said source and these absorption data or projections collected in this way are computed by means of appropriate reconstruction methods into image slices through the object under examination.

For reconstruction of computed-tomographic images from x-ray CT datasets of a computed-tomography (CT) device, i.e. from the recorded projections, what is known as a Filtered Back Projection (FBP) is used nowadays as the standard method. The data is then transformed into the frequency range. A filtering is undertaken in the frequency range and subsequently the filtered data is back transformed. With the aid of the data sorted out and filtered in this way a back projection is then carried out onto the individual voxels within the volume of interest.

Contrast and sharpness of the reconstructed CT images depend on the size of the focus, i.e. of that area of the anode of the x-ray tube which emits the x-rays. Usually an x-ray tube emits both focal radiation and also extra-focal radiation, i.e. radiation which originates outside the focus. The extra-focal radiation enlarges the emission surface of the x-ray tube and thus worsens contrast and sharpness of the image.

### SUMMARY

In at least one embodiment of the invention demonstrates a method for reconstruction of CT images wherein account is to be taken of the fact that the x-ray tube emits both focal and also extra-focal radiation. A corresponding control and processing unit, a CT system, a computer program and a computer program product are also to be demonstrated in at least one embodiment.

In the inventive method of at least one embodiment, image data of the object under examination is reconstructed from measurement data which has been recorded during a rotational movement of a radiation source of a computed tomography system around the object under examination. In such cases the radiation source emits extra-focal radiation. The image data is determined from the measurement data of an iterative algorithm. A variable is used in the iterative algorithm that contains a distribution of the extra-focal radiation.

The images which are to be obtained from an object under examination can involve image slices through the object under examination. It is further possible to determine three-dimensional images of the object under examination with at least one embodiment of the inventive method.

The radiation source of the computed-tomography system does not just emit focal radiation, i.e. radiation from the focus, a narrowly-restricted area from which the majority of the emitted radiation originates. Instead extra-focal radiation is also emitted, i.e. radiation from an area outside the focus. The extra-focal radiation differs from the focal radiation especially in its point of origin. In addition it can be distinguished from the focal radiation in respect of its quantum energy or energy distribution.

An iterative algorithm is used for reconstruction of images. Within the framework of this algorithm a first iteration pattern is calculated, in the next iteration cycle a second iteration pattern, in the next iteration cycle a third iteration pattern etc. The iteration patterns are determined by a particular computing specification being applied to the respective preceding iteration pattern. The algorithm can be aborted at a specific iteration cycle. The last of the iteration patterns corresponds to the reconstructed image which can be output as the result.

Within the iterative algorithm a specific variable is used. Included in this variable is a distribution of the extra-focal radiation. The distribution of the extra-focal radiation used can be designed in various ways, of which the especially advantageous ways are explained below. In particular the distribution can also involve the focal radiation as well as the extra-focal radiation.

The fact that the variable contains an extra-focal radiation distribution means that the extra-focal radiation is included in the iterative image reconstruction, so that the reconstructed images gain in contrast and sharpness compared to reconstruction methods without compensation for the extra-focal radiation effects.

In a development of at least one embodiment of the invention the distribution involves a local emission distribution of the radiation source. Such a local distribution specifies how much radiation is emitted from which point of the radiation source. This knowledge is important since a recorded projection corresponds to a line integral along a line from the relevant point of the radiation source through the object to a specific point of the receiver. The local emission distribution can either relate exclusively to the extra-focal radiation or also to the focal and the extra-focal radiation. In addition or as an alternative to local emission distribution, the distribution can also involve an energetic emission distribution of the radiation source. A local and energetic distribution specifies how much energy is emitted from which point of the radiation source.

In accordance with an embodiment of the invention the variable involves an operator which describes the physical measurement process. In this case the measurement process includes the origination of the radiation in the radiation source—including the extra-focal radiation, if necessary including its spatial and energetic distribution—the passage of the radiation through the object under examination and the interaction processes of the radiation with the material of the object under examination taking place in said object.

In an embodiment of the invention the variable comprises the expression

$$\int exp ( - {\int }_{L ( t , {\underline{η}}_{D} )} f ( \underline{x} ) d s ) h ( t ) d t .$$

In this case t is a local variable of the radiation source, h(t) is the distribution, ƒ(x) is the image data and

$${\int }_{L ( t , {\underline{η}}_{D} )} f ( \underline{x} ) d s$$

is a line integral along a line L(t,η_{D}) from a point t of the radiation source to a point η_{D} of the receiver. The distribution is thus included in the variable by an integration via the radiation source.

In a development of at least one embodiment of the invention a deviation is observed within the framework of the iterative algorithm between the measurement data and measurement data computed from an iteration pattern using the variable. Thus on one hand the actual measurement data is present and on the other hand data which, although it corresponds to the data in its dimension, has not been measured but has been computed.

It is especially advantageous for the iterative algorithm to be based on the formulae ƒ⁽ⁿ⁾=Bφ⁽ⁿ⁾ and φ⁽ⁿ⁺¹⁾=φ⁽ⁿ⁾+λ⁽ⁿ⁾(p−Aƒ⁽ⁿ⁾), with ƒ⁽ⁿ⁾ being an iteration pattern of the nth iteration, φ⁽ⁿ⁾ an auxiliary variable of the nth iteration, λ⁽ⁿ⁾ a selectable scalar or operator, B an operator for CT image reconstruction, A the variable, and p−Aƒ⁽ⁿ⁾ a deviation between the measurement data p and measurement data Aƒ⁽ⁿ⁾ computed from an iteration pattern ƒ⁽ⁿ⁾. In this case B can be a standard reconstruction operator, e.g. for FBP reconstruction, as is used in non-iterative reconstruction methods. B can however also be expanded in relation to such a standard reconstruction operator to the extent that B effects a part compensation of the effects of the extra-focal radiation. This means that by using such an operator B, the extra-focal radiation effects can actually not be removed by the one-off application of B to the measurement data; B can however contribute in this embodiment to the iterative algorithm removing the extra-focal radiation effects more quickly, i.e. with fewer iterations.

The inventive control and processing unit of at least one embodiment is used for the reconstruction of image data of an object under examination from measurement data of a CT system. It includes a program memory for storing program code, with the memory—if necessary as well as other program code—including program code which is suitable for executing a method of the type described above. At least one embodiment of the inventive CT system includes such a control and processing unit. It can also include the other components which are needed for recording measurement data.

At least one embodiment of the inventive computer program has available program code segments which are suitable for executing the method of the type described above when the computer program is executed on a computer.

At least one embodiment of the inventive computer program product comprises program code segments stored on a computer-readable data carrier which are suitable for executing the method of the type described above when the computer program is executed on a computer.

### BRIEF DESCRIPTION OF THE DRAWINGS

The invention will be explained below on the basis of an example embodiment. The figures show:

FIG. 1: a first schematic diagram of an example embodiment of a computed tomography system with an image reconstruction component,

FIG. 2: a second schematic diagram of an example embodiment of a computed tomography system with an image reconstruction component,

FIG. 3: a schematic diagram of an x-ray tube,

FIG. 4: a first schematic diagram for recording projections,

FIG. 5; a second schematic diagram for recording projections,

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

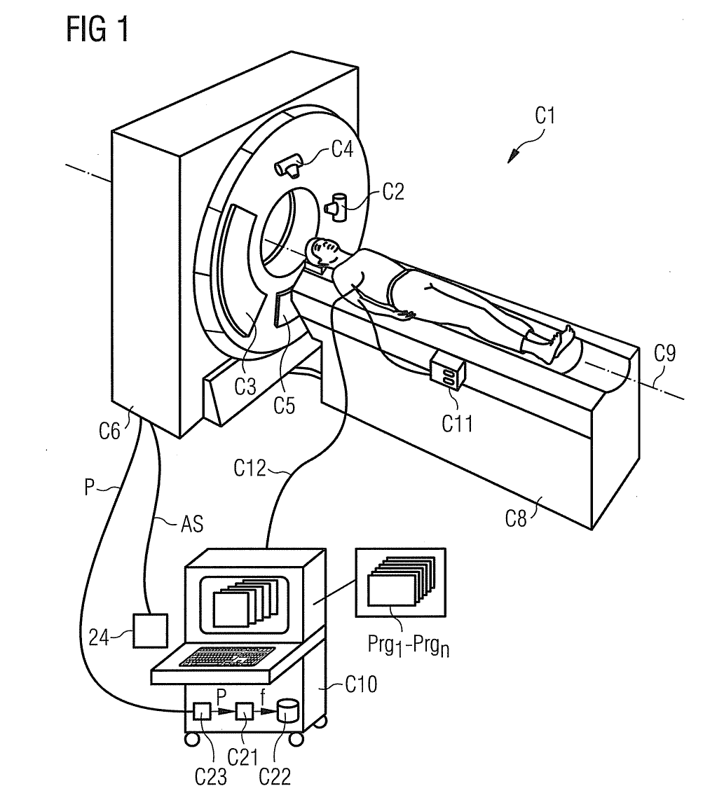

FIG. 1 first shows a schematic diagram of a first computed-tomography system C1 with an image reconstruction device C21. Located in the gantry housing C6 is a closed gantry not shown in the diagram on which are arranged a first x-ray tube C2 with a detector C3 lying opposite it. Optionally arranged in the CT system shown here is a second x-ray tube C4 with a detector C5 lying opposite it, so that a higher temporal resolution can be achieved by the radiator/detector combination additionally available, or with the use of different x-ray energy spectra in the radiator/detector system, dual-energy examinations can be undertaken.

The CT system C1 also comprises a patient couch C8 on which the patient can be pushed during the examination along a system axis C9 into the measurement field, with the scanning itself able to occur both as a pure orbital scan without forward movement of the patient exclusively in the region of interest under examination. In this case the x-ray source C2 or C4 respectively rotates around the patient. In such cases the detector C3 or C5 respectively moves in parallel in relation to the x-ray source C2 or C4 in order to record projection measurement data which is then used for reconstruction of image slices. As an alternative to a sequential scan in which the patient is pushed step-by step between the individual scans through the examination field, there is naturally also the option provided of a spiral scan, in which the patient is pushed continuously during the orbital scanning with the x-rays along the system axis C9 through the examination field between x-ray tube C2 or C4 respectively and detector C3 or C5 respectively. The movement of the patient along the axis C9 and the simultaneous orbital movement of the x-ray source C2 or C4 respectively produces a helical track for a spiral scan for the x-ray source C2 or C4 relative to the patient during the measurement.

The CT system 10 is controlled by a control and processing unit C10 with a computer program code Prg₁ through Prgₙ present in a memory. From the control and processing unit C10 acquisition control signals AS can be transmitted via a control interface 24 in order to control the CT system C1 in accordance with specific measurement protocols.

The projection measurement data p acquired by the detector C3 or C5 (also referred to as raw data below) is transmitted over a raw data interface C23 to the control and processing unit C10. This raw data p is then, if necessary after suitable pre-processing, further processed in an image reconstruction component C21. The image reconstruction component C21 is realized in this exemplary embodiment in the control and processing unit C10 in the form of software on a processor, e.g. in the form of one or more of the computer program codes Prg₁ through Prgₙ. The image data f reconstructed by the image reconstruction component C21 is then stored in a memory C22 of the control and processing unit C10 and/or output in the usual way on the screen of the control and processing unit C10. It can also be fed via an interface not shown in FIG. 1 into a network connected to the computed-tomography system C1, for example a radiological information system (RIS) and stored in mass storage accessible in this system or output as images.

The control and processing unit C10 can additionally also execute the function of an EKG, with a line C12 for deriving the EKG potentials between patient and control and processing unit C10 being used. In addition the CT system C1 shown in FIG. 1 also has a contrast media injector C11 via which additional contrast media is injected into the blood circulation of the patient so that the blood vessels of the patient, especially the heart chambers of the beating heart, can be better represented. In addition there is also the opportunity of carrying out perfusion measurements with this system.

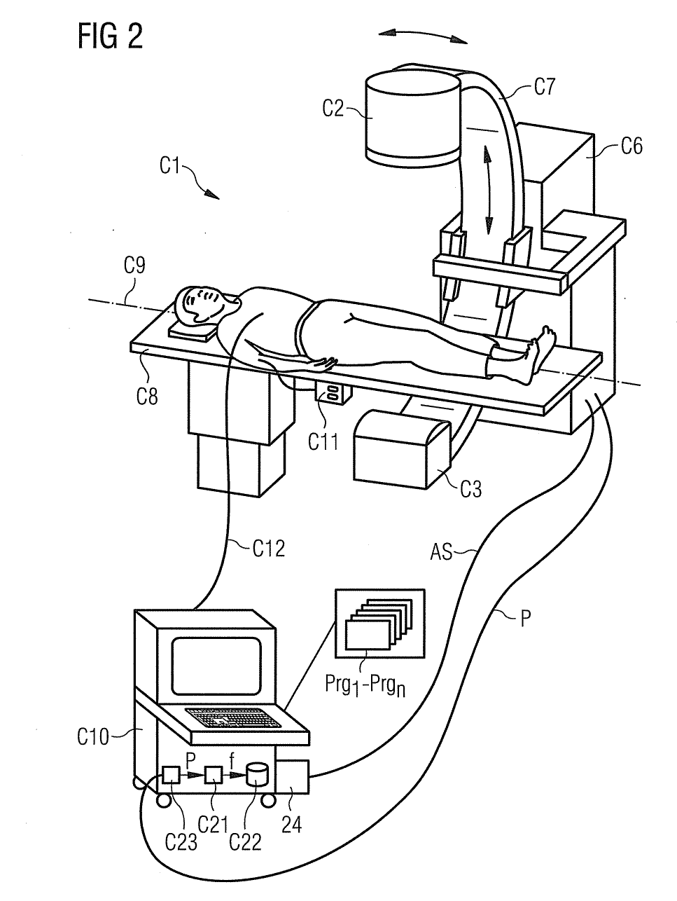

FIG. 2 shows a C-arm system, in which, by contrast with the CT system of FIG. 1, the housing C6 carries the C-arm C7, to one side of which is attached the x-ray tube C2 and to the opposite side the detector C3. The C-arm C7 is likewise hinged around a system axis C9 for a scan, said that a scan can be undertaken from a plurality of scanning angles and corresponding projection data p can be determined from a plurality of projection angles. The C-arm system C1 of FIG. 2, like the CT system from FIG. 1, has a control and processing unit C10 of the type described for FIG. 1.

Since basically the same reconstruction methods for creation of images of the object under examination can be employed in both of the tomographic x-ray systems shown, the inventive method can also be used for both systems. Furthermore the inventive method is basically also able to be used for other CT systems, e.g. for CT systems with a detector forming a complete ring.

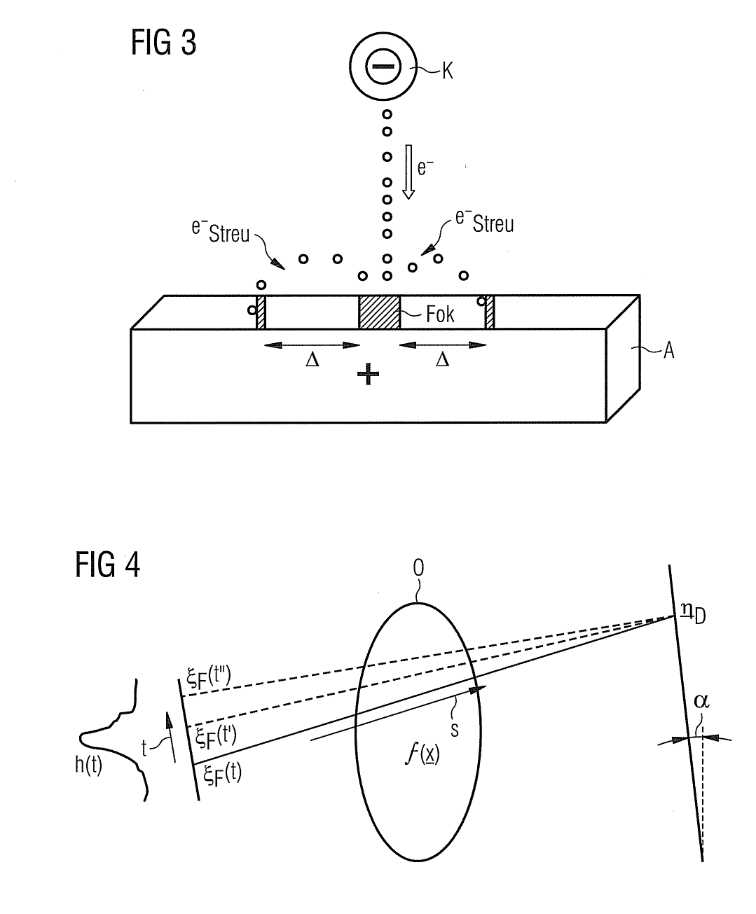

FIG. 3 shows a schematic diagram of an x-ray tube. The x-rays emitted by the x-ray tube are generated by electrons e⁻ coming out of a glow cathode K being accelerated with a high voltage present between cathode K and anode A. On the entry of the fast electrons e⁻ into the anode material, e.g. tungsten, x-radiation is produced. This largely corresponds to the Bremsstrahlung (braking radiation) of the electrons e⁻.

The sharpness of the reconstructed images essentially depends on the size of the focal point Fok on the anode A of the x-ray tube. This focal point Fok, i.e. the area of the anode A which emits the majority of the x-radiation, is referred to as the focus. Focal point dimensions of between 0.3 mm and 2 mm are usual in diagnostic x-ray tubes. Depending on the construction of the x-ray tubes, x-rays can escape outside the actual focus Fok over an area of a number of centimeters, which thus contributes to a reduction in sharpness of the image. The contrast especially is worsened by this, i.e. sharp edges are less easily detectable in the images. This parasitic x-radiation is referred to as extra-focal radiation, abbreviated to EFS in German.

The origins of the EFS can be explained as follows: A part of the electrons e⁻ hitting the anode at high speed is either scattered back elastically by the anode or they release secondary electrons in the anode A which leave the anode surface again. The energy of these scattered primary and secondary electrons e⁻_{Streu} reduced by around 20% compared to the energy of the primary electrons. Attracted by the electrical field of the anode A, the electrons e⁻_{Streu} hit the anode A a further time. The x-radiation generated by these electrons e⁻_{Streu} is the extra-focal radiation. As a result of the previous energy loss of the electrons e⁻_{Streu} the EFS is on average softer than the focal x-radiation. The point of contact of the scattered electrons e⁻_{Streu} is generally at a distance from the actual focal point Fok. The electrons e⁻_{Streu} enlarge the emission zone and thereby the imaging radiation source, they lead to a widening of the focal point Fok. This is indicated in FIG. 3 by the areas Δ alongside the focal point Fok. The proportion of the EPS in the total of the radiation emitted by the x-ray tube amounts to a maximum of around 10%, depending on the construction of the x-ray tube.

If the EFS cannot be successfully filtered out it is a component of the x-radiation used to scan the object under examination. FIG. 4 shows schematically the recording of projections through an object under examination O. The spatial attenuation distribution density distribution within the object under examination is labeled ƒ(x). This is to be determined from the reconstruction from the recorded projections. ƒ(x) can then be shown as a grey value image. h(t) designates the omission distribution on the anode; it includes the focal and the extra-focal radiation. The emission distribution h(t) thus specifies how much extra radiation exits from which point of the anode. h(t) is normalized in this case so that the integral of h(t) over the extent of anode t amounts to one.

The extension of the anode is—one-dimensionally to simplify matters—labeled t. η_{D} designates a specific detectable pixel. ξ_{F}(t), ξ_{F}(t′) and ξ_{F}(t″) are X-rays from the locations t, t′ and t″ of the anode for the detector pixel η_{D}. The track of an x-ray through the object under examination O runs along the line parameter s. The angle α involves the projection angle which changes during rotation of the radiation source/receiver pair of the CT system around the object under examination O.

For EFS correction during the image reconstruction an acquisition operator A is used which describes the physical measurement process. If A were to describe the measurement process exactly, then p=Aƒ, i.e. the recorded data p is produced by the application of the acquisition operator A to the attenuation distribution ƒ(x).

At the detector pixel η_{D} the following applies for the CT projection value at the projection angle α:

$$( Af ) ( α , {\underline{η}}_{D} ) = - ln [ \int exp ( - {\int }_{L ( {ξ}_{F} ( t ) , {\underline{η}}_{D} )} f ( \underline{x} ) d s ) h ( t ) d t ] . \qquad formula ( 1 )$$

In this case L(ξ_{F}(t),ƒ_{D}) is the line between the source point t and the target point η_{D} on the detector. The line integral

$${\int }_{L ( {ξ}_{F} ( t ) , {\underline{η}}_{D} )} f ( \underline{x} ) d s$$

in tree argument of the exponential function is thus the value of the radon transformation for the observed measurement beam, i.e. for a specific combination of detector pixel η_{D} and projection angle α. There are known fast computation methods for this computed radon transformation which is also referred to as re-projection.

Through multiplication by h(t) and the local integration with local variable t over the anode, the acquisition operator A includes the emission distribution of the anode. In the above choice of A the EFS is thus taken into account; By using the formula (1), the attenuation value which a specific detector pixel measures for a specific projection angle α can be calculated, with the x-rays emitted by the anode comprising both focal and also extra-focal radiation.

To enable the acquisition operator A to be determined, the emission distribution h(t) must be available. The determination of h(t) can be undertaken by measurements at the x-ray tube, e.g. by radiographic measurements in a laboratory.

For reconstruction of images from the recorded projections an iterative method is applied, with the acquisition operator A being used:

Let B be operator which describes the image reconstruction. In a simple form B can be a standard CT reconstruction algorithm, e.g. one of the numerous variants of filtered back projection. The embodiment of B depends among other things on the recording geometry, i.e. whether measurements are made in parallel beam, fan beam, cone beam or spiral geometry.

At the beginning of the iteration algorithm the following is defined: φ⁽⁰⁾=p, with p involving the recorded data.

In each following iteration cycle the following applies (with indices for detector pixel and projection angle having been omitted):

ƒ⁽ⁿ⁾=Bφ⁽ⁿ⁾ and φ⁽ⁿ⁺¹⁾=φ⁽ⁿ⁾+λ⁽ⁿ⁾(p−Aƒ⁽ⁿ⁾) Formula (2)

The iteration is aborted if the residuum (p−Aƒ⁽ⁿ⁾) distinguishes a predetermined small limit value, i.e. |(p−Aƒ⁽ⁿ⁾)|<ε₁, and/or if little changes between consecutive iterations, i.e. |Aƒ^{n+a)}−Aƒ⁽ⁿ⁾|<ε₂, with ε₁ and ο₂ being suitable sufficiently small barriers.

λ⁽ⁿ⁾ is a relaxation operator, one of the purposes of which is the stabilization of the results; To this end λ⁽ⁿ⁾ can carry out a noise filtering of higher local frequencies. Furthermore the convergence can be ensured by λ⁽ⁿ⁾, e.g. by under-relaxation with λ values <1. The convergence can also be accelerated by λ⁽ⁿ⁾, e.g. by over-relaxation with λ values >1. The choice of the relaxation operator λ⁽ⁿ⁾ is problem-dependent; λ⁽ⁿ⁾ but can also correspond to the identity operator.

Formula (2) means that an effort is being made to obtain as the result an image f that is as consistent as possible with the measurement data. I.e. the use of the computational acquisition operator A on f should deviate little from the actually measured projections containing the disruption by the EFS. It is therefore important for the acquisition operator A to describe the actual physical effect of the EFS as well as possible.

EFS effects which are expressed as explained in the introduction by a reduced contrast and a certain lack of sharpness of the images can be largely completely corrected by the iteration algorithm described. However a number of iterations are required as a rule in such cases.

The choice of operator B influences the speed of convergence. The better B approximates to the inverse of A, the smaller is the correction term or the residuum (p−Aƒ⁽ⁿ⁾). In the ideal case B=A⁻¹ the algorithm is already completed in iteration 0 ƒ⁽⁰⁾=Bφ⁽⁰⁾. This ideal case generally does not occur however if B is a CT reconstruction algorithm derived for ideal line integrals which does not take account of the EFS.

To accelerate the convergence, a simplified EFS correction can additionally be included. Methods namely exist for approximate correction of the EFS by local invariant deconvolution of the projections. With this method constant filter functions are used as deconvolution cores. In the creation of the filter functions the starting point is a hypothetical, centrally-positioned and rotation-symmetrical density distribution of the scanned object. The corresponding filter functions can be computed together with the geometry of the CT apparatus and the characteristics of the EFS.

The combination of a standard CT reconstruction algorithm B₀ with a simplified EFS correction C is a better approximation for the inversion of the acquisition operator A than the standard CT reconstruction algorithm B₀ alone. In this case B=B₀C is used for B in the above equations. If C were already a complete EFS correction, there would be B=A⁻¹ and the algorithm would be at its destination after iteration 0 ƒ⁽⁰⁾=Bφ⁽⁰⁾. If however C—as implied—only represents a simplified and thus approximate EFS correction, the correction term (p−Aƒ⁽ⁿ⁾) does not disappear in formula (2). This correction term corrects the difference between simplified EFS correction and the real physical model which is contained in the acquisition operator A. The smaller the difference between B and A⁻¹, the faster the algorithm converges. Thus with a good choice of B a single subsequent iteration cycle, corresponding to n=1, can suffice.

The iterative algorithm can be interpreted and implemented as an overall step method, e.g. as a generalization of SIRT (Simultaneous Iterative Reconstruction Technique) or SART (Simultaneous Algebraic Reconstruction Technique) or as a single step method, e.g. as a generalization of ART (Algebraic Reconstruction Technique). The integrals in formula (1) are to be replaced by sums for the implementation.

With the method of operation described it is even possible to deal with local variants and/or spectral variants of EFS distributions, as is explained below. The important point here however is that these effects are included in the computational simulation of the physical measurement process, i.e. in the acquisition operator A.

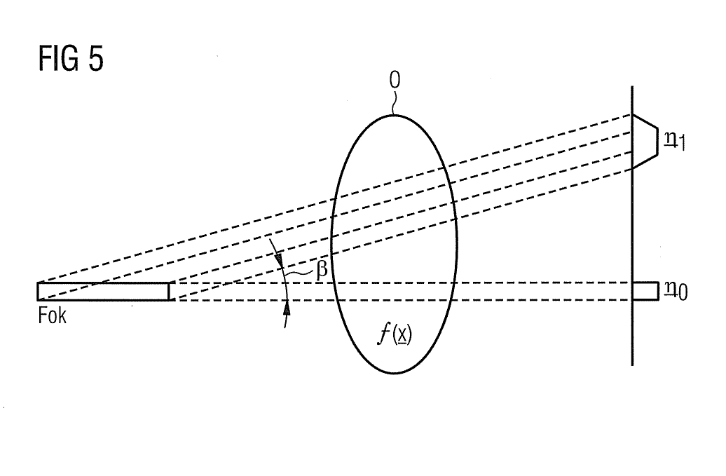

To understand the local variant handling it should be taken into account that in formula (1) the focus and the EFS area of the anode have been assumed to be linear. In reality however the starting point should be an emission surface. Depending on the angle of view onto the focal point this appears to vary in width. This is illustrated in FIG. 5.

The detector pixel ƒ₀ which looks onto the x-ray tube from the front, i.e. is arranged centrally, sees an almost one-dimensional focus Fok. By contrast, for the detector pixel ƒ₁ which looks from a sideways direction at an angle β onto the x-ray tube, the focus Fok appears planar. To take this into account the emission distribution h(t) in the formula (1) can be replaced by a family of functions h_{β}(t), with β specifying the respective fan angle corresponding to the positioning of the detector pixel.

To understand the spectral variant handling it should be taken into consideration that the EFS exhibits a softer energy spectrum than the focal radiation. This can be taken into account in the acquisition operator A by each emission point t of the anode being assigned a specific emission spectrum Sₜ(E). Formula (1) in this case becomes

$$( Af ) ( α , {\underline{η}}_{D} ) = - ln [ \int \int exp ( - {\int }_{L ( {ξ}_{F} ( t ) , {\underline{η}}_{D} )} f ( \underline{x} , E ) d s ) {S}_{t} ( E ) d Eh ( t ) d t ] . \qquad Formula 3$$

In this case ƒ(x,E) is the local and energy-dependent attenuation distribution in the object under examination.

The disadvantage of this method of observation is that the object function ƒ(x) must be known in energy-dependent terms, which is generally not the case. This would thus require additional assumptions, e.g. that specific areas of the object under examination are water-equivalent or consist of another material such as bone for example with its respective mass attenuation coefficient, whereby the densities can vary.

Taking full account of the spectral EFS effects would also demand considerable computing power. A simplified consideration is possible by two different effective or average x-ray quanta energies or two different spectra being assumed for focal and extra-focal radiation components.

The invention has been described above using an exemplary embodiment. It goes without saying that numerous changes and modifications are possible without departing from the framework of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combineable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for determining image data of an object under examination from measurement data, the measurement data having been detected during a rotating movement of a radiation source of a computed tomography system around the object under examination, with the radiation source emitting focal and extra-focal radiation, the method comprising:
determining the image data from the measurement data by use of at least one iterative algorithm, a variable used in the at least one iterative algorithm containing a distribution of the extra-focal radiation.

2. The method as claimed in claim 1, wherein the distribution involves a local emission distribution of the radiation source.

3. The method as claimed in claim 1, wherein the distribution involves a local emission distribution of the focal and extra-focal radiation of the radiation source.

4. The method as claimed in claim 1, wherein the distribution involves an energetic emission distribution of the radiation source.

5. The method as claimed in claim 1, wherein the variable involves an operator which describes a physical measurement process.

6. The method as claimed in claim 1, wherein
the variable comprises
$$\int exp ( - {\int }_{L ( t , {\underline{η}}_{D} )} f ( \underline{x} ) d s ) h ( t ) d t ,$$
with
t being a local variable of the radiation source (C2, C4, A) h(t) being the distribution,
ƒ(x) being the image data, and
$${\int }_{L ( t , {\underline{η}}_{D} )} f ( \underline{x} ) d s$$
being a line integral along a line L(t,ƒ_{D}) from a point t of the radiation source (C2, C4, A) to a point ƒ_{D} of the receiver.

7. The method as claimed in claim 1, wherein,
within the framework of the iterative logarithm, a deviation is observed between the measurement data and measurement data computed from an iteration pattern using the variable.

8. The method as claimed in claim 1, wherein the iterative algorithm is based on the formulae ƒ⁽ⁿ⁾=B·φ⁽ⁿ⁾ and φ⁽ⁿ⁺¹⁾=φ⁽ⁿ⁾+λ⁽ⁿ⁾(p−A·f⁽ⁿ⁾), with
ƒ⁽ⁿ⁾ being an iteration pattern of the end iteration,
φ⁽ⁿ⁾ being an auxiliary variable of the end iteration,
λ⁽ⁿ⁾ being a selectable operator,
B being an operator for CT image reconstruction,
A being the variable, and
p−A·ƒ⁽ⁿ⁾ being a deviation between the measurement data p and measurement data ƒ⁽ⁿ⁾ computed from an iteration pattern) A·ƒ⁽ⁿ⁾.

9. The method as claimed in claim 8, wherein the operator B effecting a part compensation of the effects of the extra-focal radiation.

10. A control and processing unit for determining image data of an object under examination from measurement data of a CT system, comprising:
a program memory for storage of program code, the program code being present in the program memory and carrying out the method in accordance with claim 1 when executed.

11. A CT system comprising a control and processing unit as claimed in claim 10.

12. A computer program comprising program code segments for carrying out the method as claimed in claim 1 when the computer program is executed on a computer.

13. A computer program product, comprising program code segments of a computer program stored on a computer-readable data carrier to execute the method as claimed in claim 1 when the computer program is executed on a computer.

14. The method as claimed in claim 2, wherein the distribution involves an energetic emission distribution of the radiation source.

15. The method as claimed in claim 2, wherein the variable involves an operator which describes a physical measurement process.

16. A computer readable medium including program segments for, when executed on a computer device, causing the computer device to implement the method of claim 1.
